(19) United States
(12) Patent Application Publication
(10) Pub. No.: US 2005/0247644 A1
(43) Pub. Date: Nov. 10, 2005

(54) Method and apparatus for treatment of wastewater

(76) Inventors: Everett Paul Chapple, Brampton (CA); Paul Champigny, Toronto (CA)

Correspondence Address: MIN, HSIEH & HACK LLP, 8270 GREENSBORO DRIVE, SUITE 630, MCLEAN, VA, 22102, US

(21) Appl. No.: 10/841,430

(22) Filed: May 10, 2004

(51) Int. Cl. C02F 1/66

(52) U.S. Cl. 210/749; 210/767; 210/206

(57) ABSTRACT

An apparatus for treating wastewater downstream from a drain includes an inlet for connecting to a pipe downstream from the drain. The inlet receives the wastewater. A collection chamber is in fluid connection with the inlet and is located downstream of the inlet. A pH adjustment chamber contains a pH adjustment media therein, is in fluid connection with the collection chamber and is located downstream thereof. A filter is disposed between the collection chamber and the pH adjustment chamber and an outlet is in fluid connection with the pH adjustment chamber for discharging the wastewater. The wastewater flows into the apparatus through the inlet, into the collection chamber, through the filter, into the pH adjustment chamber and out the outlet.

### FIELD OF THE INVENTION

The present invention relates in general to wastewater treatment, and more particularly to the treatment of wastewater drained from a sink or tub, to debris and to reduce acidity.

### BACKGROUND OF THE INVENTION

Blockage or reduction of wastewater flow downstream from a drain of a sink is problematic and is often caused by debris such as garbage and particulate matter that is dropped, or discarded in the sink. The garbage or particulate matter then flows down the drain and builds up in a downstream pipe to cause flow reduction or blockage. Current systems that are designed to trap or remove garbage include a bottle trap or dome trap that is located under the sink and designed to catch the garbage as it exits the sink. A typical bottle trap is shown mounted under a sink in FIG. 1. The trap is indicated generally by the numeral 20 and the sink is indicated by the numeral 22. As shown, the trap 20 is mounted downstream of the drain of the sink 22 such that the bottle receives garbage that is inadvertently washed down the drain. These bottle systems 20 are periodically cleaned out to remove the entrapped garbage.

Such bottle systems suffer several disadvantages, however. The bottle trap generally has a small capture capacity which leads to fast filling and potential plugging. Such systems therefore require very frequent cleaning. Also, while these systems are generally effective for collecting large particles, they allow smaller sized particles to escape the bottle trap, potentially causing clogging of pipes downstream of the trap. Further, the bottle trap scours very quickly and large flush flows result in the removal of at least some of the previously collected garbage or particulate.

In another unrelated problem, highly acidic (low pH) water that is poured or spilled down the drain of a sink causes damage to pipes and is not permitted by law, to be drained into city sewer systems. Systems have been designed to deal with certain acidic substances that are poured down a drain. One such system is an under-sink basin that is intended to treat acidic wastewater before the wastewater enters the city sewer system. A typical under-sink basin is shown in FIG. 2 and is indicated generally by the numeral 24. Although not shown, the under-sink basin 24 is designed to be located directly under a sink, downstream of the sink drain to receive and treat the wastewater after it exits the sink drain and prior to entering the city sewer system. Such basins are generally made of polypropylene and include marble chips that are located within the basin to contact the wastewater as the wastewater flows through the basin. The marble chips are periodically removed and replaced.

Such under-sink basins suffer disadvantages, however. In particular, these basins are very large and require a high retention time that is often not provided. Further, the use of marble chips to contact the acidic wastewater, are not effective as the pH value of wastewater is not neutralized within two and a half hours of dwell time. Further still, the under-sink basin is not designed to collect garbage or particulate matter as such garbage and particulate matter plugs the basin.

It is therefore desirable to provide a system or systems for treating wastewater that obviates or mitigates at least some of the disadvantages of the prior art.

### SUMMARY OF THE INVENTION

In one aspect of an embodiment of the present invention, there is provided an apparatus for treating wastewater downstream from a drain. The apparatus includes an inlet for connecting to a pipe downstream from the drain. The inlet receives the wastewater. A collection chamber is in fluid connection with the inlet and is located downstream of the inlet. A pH adjustment chamber contains a pH adjustment media therein, is in fluid connection with the collection chamber and is located downstream thereof. A filter is disposed between the collection chamber and the pH adjustment chamber and an outlet is in fluid connection with the pH adjustment chamber for discharging the wastewater. The wastewater flows into the apparatus through the inlet, into the collection chamber, through the filter, into the pH adjustment chamber and out the outlet.

In another aspect of an embodiment of the present invention, there is provided a method of treating wastewater in a treatment apparatus downstream from a drain. The method includes receiving the wastewater through an inlet of the treatment apparatus. Debris is collected in a collection chamber of the apparatus, as the wastewater passes through the collection chamber. The wastewater is filtered after collecting the debris and the pH of the wastewater is adjusted using a pH adjustment media in a pH adjustment chamber as the wastewater passes therethrough. The water is discharged from the apparatus through an outlet therein.

In still another aspect of an embodiment of the present invention, there is provided a water treatment apparatus for treating wastewater from a drain. The water treatment apparatus includes a connector having an outlet. The connector is used for connecting to a drainpipe. The apparatus also includes a cartridge removably attachable to the connector. The cartridge includes an inlet and a collection chamber in fluid connection with the inlet. The collection chamber is for receiving water downstream of the inlet. A pH adjustment chamber is for containing a pH adjustment media therein, is in fluid connection with the collection chamber and is located downstream thereof. A filter is disposed between the collection chamber and the pH adjustment chamber. The pH adjustment chamber is in fluid connection with the outlet for discharging the wastewater. The wastewater flows into the cartridge from the inlet, into the collection chamber, through the filter, into the pH adjustment chamber and out the outlet.

In yet another aspect of the present invention, there is provided a cartridge for removably attaching to a connector having an outlet, the connector for connecting to a drainpipe. The cartridge includes a cartridge inlet and a collection chamber for fluid connection with the inlet. The collection chamber receives water downstream of the inlet. A pH adjustment chamber is for containing a pH adjustment media therein. The pH adjustment chamber is in fluid connection with the collection chamber and located downstream thereof. A filter is disposed between the collection chamber and the pH adjustment chamber and the pH adjustment chamber is in fluid connection with the outlet for discharging the wastewater. The wastewater flows into the cartridge from the inlet, into the collection chamber, through the filter, into the pH adjustment chamber and out to the outlet.

Advantageously, the method and apparatus for treatment of wastewater of the present invention provides for treatment of water to remove debris such as garbage and particulate matter and for adjustment of pH for acidic wastewater. In one particular aspect of the present invention, debris is removed and acidic wastewater is treated to reduce acidity (increase pH) in a simple cartridge that is attached under a sink. A chamber area collects the debris and can be visually checked and cleaned out when required.

Debris such as garbage and particulate matter that is washed down the drain of a sink or tub, is collected in the collection chamber, thereby inhibiting the debris from plugging pipes downstream. Also, wastewater that has a low pH is treated to inhibit the wastewater from corroding or harm the plumbing downstream of the pipe. Further, the pH adjustment chamber inhibits the discharge of water that does not comply with local by-laws. The filter between the collection chamber and the pH adjustment chamber inhibits the flow of particulate matter from the collection chamber and inhibits clogging or flow reduction downstream.

### BRIEF DESCRIPTION OF THE DRAWINGS

The present invention will be better understood to the drawings and to the following description of the preferred embodiments, in which:

FIG. 1 is a perspective view of a typical prior-art bottle trap shown mounted under a sink;

FIG. 2 is a perspective view of a typical prior-art under-sink basin;

FIG. 3 is a cross-sectional side view of an apparatus for treating wastewater according to an embodiment of the present invention;

FIG. 4 is a perspective view of the apparatus of FIG. 4 shown mounted under a sink; and

FIG. 5 is a perspective view of an apparatus for treating wastewater according to an alternative embodiment of the present invention.

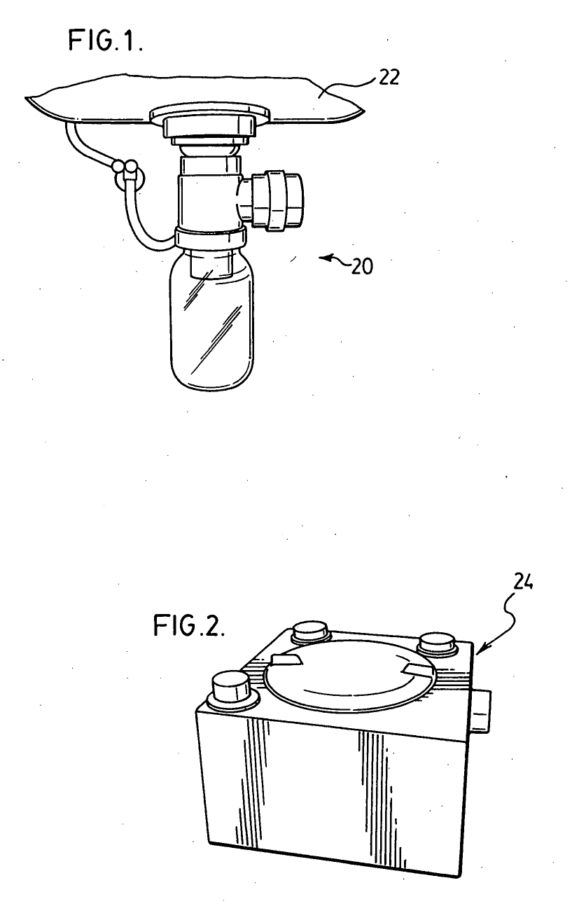

### DETAILED DESCRIPTION OF THE PREFERRED EMBODIMENTS

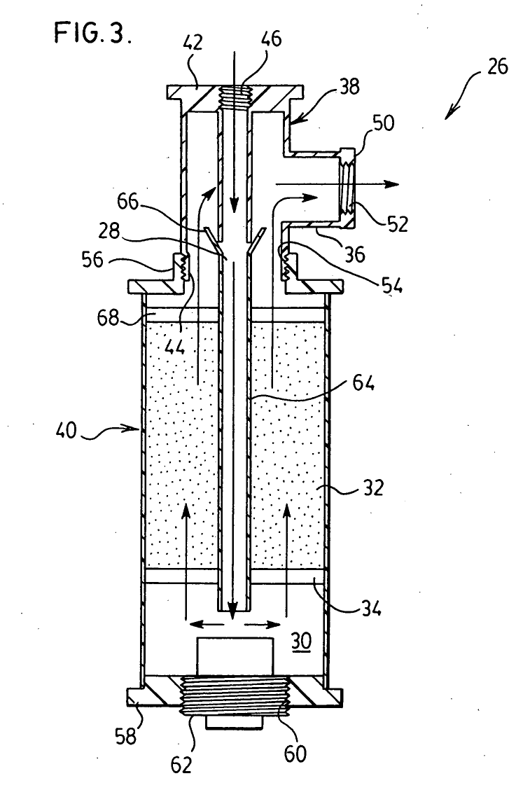

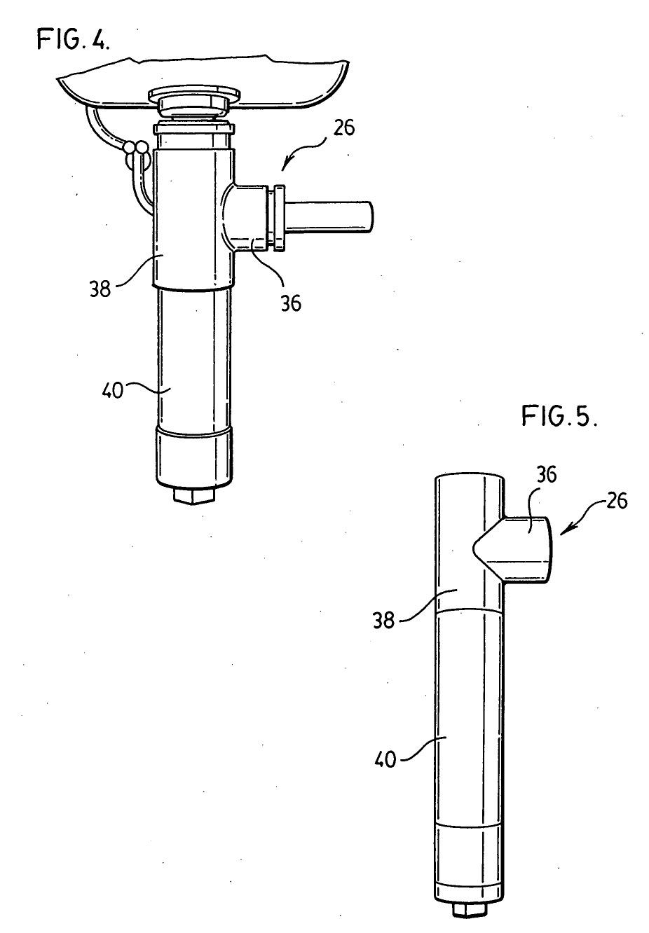

Reference is made to FIGS. 3 and 4 to describe the apparatus for treating wastewater downstream from a drain, according to a particular aspect of an embodiment of the present invention. The apparatus, indicated generally by the numeral 26 includes an inlet 28 for connecting to a pipe downstream from the drain. The inlet 28 receives the wastewater. A collection chamber 30 is in fluid connection with the inlet 28 and is located downstream of the inlet 28. A pH adjustment chamber 32, for containing a pH adjustment media therein, is in fluid connection with the collection chamber 30 and is located downstream thereof. A filter 34 is disposed between the collection chamber 30 and the pH adjustment chamber 32 and an outlet 36 is in fluid connection with the pH adjustment chamber 32 for discharging the wastewater. The wastewater flows into the apparatus 20 through the inlet 28, into the collection chamber 30, through the filter 34, into the pH adjustment chamber 32 and out the outlet 36.

The apparatus 20 for treating wastewater downstream from a drain will now be described in further detail with reference to the same Figures. The apparatus 20 includes a connector 38 that provides the connection between the drain from the sink and a cartridge 40 that includes the collection chamber 30, the pH adjustment chamber 32 and the filter 34. In the present embodiment, the apparatus 20 is made of polyvinyl chloride (PVC).

The connector 38, acts as a simple T-type connector pipe with a pair of opposing threaded ends, referred to as a first end and a second end 42, 44. The first end 42 of the connector is closed with the exception of an internally threaded bore 46 extending through the center of the first end 42. It will be appreciated that the internal threads of the bore 46 are sized to mate with external threads of a sink drain (not shown), to thereby provide mechanical connection between the connector 38 and a sink. The threaded connection is water tight to ensure that water that drains from the sink enters the apparatus 26 and then is discharged into the sewer system.

The second end 44 of the connector 38 is generally cylindrical and is externally threaded for threaded engagement with the cartridge 40.

The outlet 36 is shown extending from a sidewall of the connector 38, thereby forming the T-shape referred to above. The outlet 36 includes a side end 50 that is closed with the exception of an internally threaded bore 52. It will be understood that the internal threads of the bore 52 are sized to mate with external threads of a pipe into which the wastewater is discharged from the apparatus 26.

The cartridge 40 is shown in FIGS. 3 and 4, in threaded engagement with the connector 38. Clearly, the second end 44 of the connector 38 threads into an internally threaded bore 54 in a first end 56 of the cartridge 40. Thus, the first end 56 of the cartridge 40 is closed with the exception of the internally threaded bore 54.

The cartridge 40 will now be described with reference to FIGS. 3 and 4 and with reference to the flow of wastewater therethrough. The cartridge 40 is made of a suitable material such as schedule 40 or schedule 80 clear polyvinyl chloride (PVC), is generally cylindrically shaped and includes the first end 56 that is attached to the connector 38, and a second end 58. The second end 58 includes an internally threaded bore 60 that receives an externally threaded plug 62 for sealing the second end 58.

A connecting down pipe 64 extends from the first end 56, toward the second end 58, and is concentric with the generally cylindrically shaped cartridge 40. As shown, the connecting down pipe 64 does not extend the full distance to the second end 58, but instead terminates at a location spaced from the second end 58.

At the first end 56 of the cartridge 40, a PVC seat 66 is fixed to the end of the connecting down pipe 64 and protrudes from the first end 56 of the cartridge. As shown in FIG. 3, the seat 66 is generally funnel shaped for receiving an end of a sink down pipe therein and for forming a seal therewith, when in use. Clearly, when the connector 38 is connected to the sink, a down pipe of the sink extends into the connector 38 and is seated in and abuts the seat 66. A seal is formed using an O-ring of, for example, Viton™ or Teflon™. Thus, the seat 66 provides for fluid connection between the down pipe from the sink and the connecting down pipe 64. It will be understood that wastewater that is drained into the sink down pipe flows through the sink down pipe within the connector 38 and through the seat 66, into the connecting down pipe 64. Therefore, the end of the connecting down pipe 64 functions as the inlet 28 into the cartridge, for connecting to a sink down pipe and receiving wastewater therein.

The connecting down pipe 64 is fixed in place, concentric with the cartridge 40, by a pair of filter plates, including the first filter plate 34 and a second filter plate 68 that are generally disc shaped and extend across the interior of the cartridge 40, concentric therewith. The filter plates 34, 68 are sized for interference fit with the interior of the wall of the cartridge 40 and both include holes in the center thereof, through which the connecting down pipe 64 extends. In the present embodiment, the holes in the filter plates 34, 68 are sized to provide an interference fit with the connecting down pipe 64, to retain the connecting down pipe 64 in place.

The first and second filter plates 34, 68 subdivide the interior of the cartridge 40 to define chambers therein. More particularly, the first filter plate 24 is spaced from the second end 58 of the cartridge 40, defining the collection chamber 30 between the first filter plate 24 and the second end 58. The second filter plate 68 is spaced from the first end 56 of the cartridge 40 and from the first filter plate 24, defining the pH adjustment chamber 32 between the first filter plate 24 and the second filter plate 68.

The collection chamber 30, adjacent the second end 58, is a generally hollow chamber (prior to use) and receives the wastewater from the connecting down pipe 64. Since the collection chamber 30 is divided from the pH adjustment chamber 32 by the first filter plate 34, and the wastewater flows upwardly from the collection chamber 30, through the first filter plate 34 and into the pH adjustment chamber 30, debris such as garbage and particulate matter collects in the collection chamber 30. The externally threaded plug 62 is removable for cleaning or removing debris from the collection chamber 30. When inserted in the threaded bore 60, the plug 62 seals the second end 58 of the cartridge 40.

The pH adjustment chamber 32 includes a pH adjustment media therein for use in reducing acidity (raising the pH) of acidic wastewater. The pH adjustment media is a suitable alkali material through which the wastewater flows. In one embodiment of the present invention, the pH adjustment media is a dry granular product that is loaded into the pH adjustment chamber 32 and is consumed during neutralization of acidic wastewater as acidic wastewater flows around the granules. One such suitable alkali material is PHIX™ media available through Green Turtle Technologies Ltd., PHIX™ Division, 12 Madison Avenue, Toronto, Ontario, Canada, M5R 2S1. As shown in FIG. 3, the pH adjustment media is contained within the pH adjustment chamber 32 by the first and second filter plates 34, 68.

Acidic wastewater that flows through the pH adjustment chamber 32 is therefore neutralized by the pH adjustment media, after debris from the wastewater is collected in the collection chamber 30.

In use, the connector 38 is connected to a drain of a sink, as shown in FIG. 4. As described above, this is accomplished by threaded connection between the sink drain and the connector 38. In connecting the connector 38 to the sink drain, a sink down pipe from the sink, extends downwardly into the connector 38.

Next, the cartridge 40 is attached to the connector 38 by threaded engagement as described above. In attaching the cartridge 40 to the connector, the sink down pipe is pressed into the seat 66 and a seal is formed with the seat 66 using an O-ring. The outlet 36 of the connector is then attached to a pipe into which the wastewater is discharged from the apparatus 26.

When wastewater drains from the sink, the wastewater flows down the sink down pipe, through the seat 66, through the connecting down pipe 64 and into the collection chamber 30. Debris such as garbage and particulate matter is collected in the collection chamber 30 by gravity and the wastewater flows upwardly through the first filter plate 34 and into the pH adjustment chamber 32. The pH of acidic water is raised in the pH adjustment chamber and the pH adjusted wastewater flows through the second filter plate 68. From here, the wastewater proceeds through the bore 54 in the first end 56 of the cartridge, into the connector 38. The wastewater then flows out the outlet 36.

The present invention has been described by way of example. Modifications and variations to the above-described embodiment are possible. For example, while the above-described embodiment refers specifically to the use of the apparatus with a drain of a sink, the apparatus is not limited to drains of sinks and can be used with, for example, tubs, basins, drains or furnace condensate outlets (or drains). Although the cartridge, is described as being made of polyvinyl chloride, other suitable materials can be used, such as polyethylene and polypropylene. Also, other suitable materials such as glass and plastic can be used for various parts of the apparatus.

Although the outlet is described as including a side end 50 with an internally threaded bore sized to mate with external threads of a pipe into which the wastewater is discharged, other connection means are possible. For example, the outlet can be a compression fitting, a socket fitting, or any other suitable connection.

Also, although the size of the apparatus is not described in detail, it will be understood that the size of the apparatus can vary for different drain sizes, for example. FIGS. 4 and 5 show two embodiments that differ in size for different sized drains. Also, the shape of many of the elements can vary while still performing the same function.

Further still, instead of being two detachable parts, the connector and the cartridge can be fixed together or can be a single part. Also, the cartridge can be replaceable or can be refilled with new pH adjustment media as necessary.

Still other modifications and variations may occur to those skilled in the art. All such modifications and variations are believed to be within the sphere and scope of the present invention.

1. An apparatus for treating wastewater downstream from a drain, the apparatus comprising:
an inlet for connecting to a pipe downstream from said drain, said inlet receiving said wastewater;
a collection chamber in fluid connection with said inlet, said collection chamber located downstream of said inlet;
a pH adjustment chamber for containing a pH adjustment media therein, the pH adjustment chamber being in fluid connection with said collection chamber and located downstream thereof;
a filter disposed between said collection chamber and said pH adjustment chamber;
an outlet in fluid connection with said pH adjustment chamber for discharging said wastewater,
such that said wastewater flows into said apparatus through said inlet, into said collection chamber, through said filter, into said pH adjustment chamber and out said outlet.

2. The apparatus according to claim 1, further comprising a down pipe connector for directing said wastewater into said collection chamber.

3. The apparatus according to claim 1, further comprising a second filter disposed between said pH adjustment chamber and said outlet, said filter for retaining said pH adjustment media in said pH adjustment chamber.

4. The apparatus according to claim 1, wherein the pH adjustment chamber comprises a column for containing said pH adjustment media therein, said column for receiving the flow of wastewater upwardly therethrough.

5. The apparatus according to claim 1, wherein said collection chamber and said pH adjustment chamber comprise portions of a column that are divided by said filter, said collection chamber being disposed in a bottom portion of said column.

6. The apparatus according to claim 5, further comprising a down pipe disposed within said column, for directing said wastewater downwardly into said collection chamber, prior to said wastewater passing upwardly through said filter and into said pH adjustment chamber.

7. The apparatus according to claim 6, wherein said down pipe is concentric with said column.

8. The apparatus according to claim 1, wherein an end of said collection chamber includes a removably attachable plug for removing to clean out said collection chamber and for attaching to seal said end.

9. A method of treating wastewater in a treatment apparatus downstream from a drain, comprising:
receiving the wastewater through an inlet of said treatment apparatus;
collecting debris in a collection chamber of said apparatus, as the wastewater passes through said collection chamber;
filtering the wastewater after collecting said debris;
adjusting pH of the wastewater using a pH adjustment media in a pH adjustment chamber as the wastewater passes therethrough; and
discharging the water from said apparatus through an outlet therein.

10. The method according to claim 9, wherein said collecting debris includes said wastewater flowing from said inlet, downwardly into said collection chamber.

11. The method according to claim 10, wherein said adjusting pH includes said wastewater flowing upwardly through said pH adjustment chamber.

12. The method according to claim 9, further comprising filtering said wastewater after adjusting said pH.

13. A water treatment apparatus for treating wastewater from a drain, comprising:
a connector having an outlet, said connector for connecting to a drainpipe; and
a cartridge removably attachable to said connector, the cartridge comprising: a cartridge inlet; a collection chamber in fluid connection with said inlet, said collection chamber for receiving water downstream of said inlet; a pH adjustment chamber for containing a pH adjustment media therein, the pH adjustment chamber being in fluid connection with said collection chamber and located downstream thereof; and a filter disposed between said collection chamber and said pH adjustment chamber, said pH adjustment chamber being in fluid connection with said outlet for discharging said wastewater, such that said wastewater flows into said cartridge from said inlet, into said collection chamber, through said filter, into said pH adjustment chamber and out said outlet.

14. The apparatus according to claim 13, wherein said cartridge further comprises a down pipe for directing said wastewater into said collection chamber.

15. The apparatus according to claim 13, wherein said cartridge further comprises a second filter disposed downstream of said pH adjustment chamber, said filter for retaining said pH adjustment media in said pH adjustment chamber.

16. The apparatus according to claim 13, wherein the pH adjustment chamber comprises a column for containing said pH adjustment media therein, said column for receiving the flow of wastewater upwardly therethrough.

17. The apparatus according to claim 13, wherein said collection chamber and said pH adjustment chamber comprise portions of a column that are divided by said filter, said collection chamber being disposed in a bottom portion of said column.

18. The apparatus according to claim 17, further comprising a down pipe disposed within said column, for directing said wastewater downwardly into said collection chamber, prior to said wastewater passing upwardly through said filter and into said pH adjustment chamber.

19. The apparatus according to claim 18, wherein said down pipe is concentric with said column.

20. The apparatus according to claim 13, wherein an end of said collection chamber includes a removably attachable plug for removing to clean out said collection chamber and for attaching to seal said end.

21. A cartridge for removably attaching to a connector having an an outlet, the connector for connecting to a drainpipe, the cartridge comprising:
a cartridge inlet;
a collection chamber for fluid connection with said inlet, said collection chamber for receiving water downstream of said inlet;
a pH adjustment chamber for containing a pH adjustment media therein, the pH adjustment chamber being in fluid connection with said collection chamber and located downstream thereof; and
a filter disposed between said collection chamber and said pH adjustment chamber, said pH adjustment chamber being in fluid connection with said outlet for discharging said wastewater, such that said wastewater flows into said cartridge from said inlet, into said collection chamber, through said filter, into said pH adjustment chamber and out to said outlet.

22. The cartridge according to claim 21, further comprising a down pipe for directing said wastewater into said collection chamber.

23. The cartridge according to claim 21, further comprising a second filter disposed downstream of said pH adjustment chamber, said filter for retaining said pH adjustment media in said pH adjustment chamber.

24. The cartridge according to claim 21, wherein the pH adjustment chamber comprises a column for containing said pH adjustment media therein, said column for receiving the flow of wastewater upwardly therethrough.

25. The cartridge according to claim 21, wherein said collection chamber and said pH adjustment chamber comprise portions of a column that are divided by said filter, said collection chamber disposed in a bottom portion of said column.

26. The cartridge according to claim 25, further comprising a down pipe disposed within said column, for directing said wastewater downwardly into said collection chamber, prior to said wastewater passing upwardly through said filter and into said pH adjustment chamber.

27. The cartridge according to claim 26, wherein said down pipe is concentric with said column.

28. The cartridge according to claim 21, wherein an end of said collection chamber includes a removably attachable plug for removing to clean out said collection chamber and for attaching to seal said end.
